(19) United States
(12) Patent Application Publication
(10) Pub. No.: US 2026/0229109 A1
(43) Pub. Date: Aug. 6, 2026

(54) Alert and safety device for electromechanical equipment

(71) Applicant: SURUS CONNECT, BEGLES (FR)

(72) Inventor: Eliot DUPRE, VILLENAVE D'ORNON (FR)

(21) Appl. No.: 19/466,856

(22) Filed: Feb. 2, 2026

(30) Foreign Application Priority Data
Feb. 4, 2025 (FR) FR2501132

(51) Int. Cl. G08B 25/01

(52) U.S. Cl. CPC G08B 25/016

(57) ABSTRACT

The invention relates to an alert and safety device (1) for an electromechanical equipment item including a single trigger device (10) comprising an event detection module, a first communication unit and a control unit; a receiver device (11) including a second communication unit able to exchange with said first communication unit and an action unit able to interrupt the operation of an electromechanical equipment item with which it is associated; following detection of an event of a first type, the control unit is arranged to transmit to the receiver device (11), an instruction to stop the equipment item and the action unit of said receiver device (11) is arranged to interrupt the operation of said electromechanical equipment item, following detection of an event of a second type by said detection module, the control unit is adapted to transmit a distress alert.

### TECHNICAL FIELD

The invention relates to the technical field of safety devices, and in particular safety devices for electromechanical equipment.

The invention also relates to the field of alert devices.

### PRIOR ART

Every year, French farm workers report over 70,000 workplace accidents. The sector's heavy workload and high level of mechanization expose farm workers to the risk of workplace accidents. What's more, the wide variety of activities, and therefore of associated machines, reinforces this exposure.

Faced with this situation, some farmers are already equipping themselves with personal protective equipment (PPE) as well as machine guards and other collective protective equipment (CPE). However, there are still accidents that escape these tools and do not have a dedicated solution.

Lone Worker Alarm (LWA) devices do exist, but are widely rejected by users as having several drawbacks. Firstly, the algorithms are inadequate and generate too many nuisance alerts. They also represent a heavy mental burden for the user, since these tools must be recharged and carried by the user on a regular basis, and the lack of network coverage in dead zones is a major problem. Finally, these devices are not connected to the machines, which is a major source of accidents. In fact, existing LWA devices do not communicate with machines in the worker's environment, either to shut down the machine to avoid an accident or a secondary accident, or to take these machines into account in the risk assessment.

LWA devices are also known to be used, but they do not allow connection to machines, notably because they do not have compatible receiver boxes and therefore no physical or electrical connection to the machines, the algorithms are not adapted and the hardware is not the same. Furthermore, they do not systematically cover dead zones, which are often found in agricultural areas.

It is also known to use wireless emergency stop devices connected to the machine, but these do not trigger a distress call.

Industrial fields can also be affected by the existence of all kinds of electromechanical devices.

The invention is therefore placed in this context and seeks to resolve all the aforementioned drawbacks. The aim of the invention is to provide a device that prevents and avoids accidents and, in the event of an accident, mitigates the consequences and speeds up their management, but also allows LWA devices to be adapted to machine connectors, so as to achieve a connection in the broadest sense between them.

### Presentation of the Invention

The invention relates to an alert and safety device for an electromechanical equipment item including a single trigger device comprising an event detection module, a first communication unit able to exchange data and a control unit; at least one receiver device including a second communication unit able to exchange data with said first communication unit and an action unit able to interrupt the operation of an electromechanical equipment item with which it is associated; remarkable in that following detection of an event of a first type by said detection module, the control unit is arranged to transmit to the receiver device, via the first and second wireless communication units, an instruction to stop the equipment item and the action unit of said receiver device is arranged to, upon receipt of said stop instruction, interrupt the operation of said electromechanical equipment item, following detection of an event of a second type by said detection module, the control unit is adapted to transmit, via the first communication unit, a distress alert.

The single trigger device can include a housing on which the detection module is mounted. The event detection module can be used to detect both an event of the first type and an event of the second type, although the two types of event are distinct. Depending on the interaction between the user and the trigger device, the event detection module can detect whether the user is facing an event of the first type or an event of the second type. The trigger device includes a first communication unit capable of exchanging data using a communication network, which may be wireless.

The safety device includes at least one receiver device adapted to be mounted on an electromechanical equipment item such as agricultural or industrial machinery. The receiver device includes an action unit and can be mounted so as to be directly connected to the power supply of the electromechanical equipment item for its own power supply. In another embodiment, the receiver device can be mounted so as to be directly connected to the power supply of the electromechanical equipment item, both for its own power supply but also so that said action unit can interrupt the operation of said electromechanical equipment item. In one embodiment, the receiver device may include a universal plug adapted to the type of machine on which it is to be mounted. In another embodiment, the receiver device can be fitted with specific connectors adapted to the type of machine on which it is to be mounted. The receiver devices can be mounted on a wide variety of existing machines. This means that a wide variety of receiver devices can be used to adapt to different existing machines.

The action unit can interrupt the operation of the electromechanical equipment item either directly or indirectly. The receiver device includes a second communication unit capable of exchanging data using a communication network, which may be wireless. Thus, the first communication unit of the trigger device and the second communication unit of the receiver device can be adapted to communicate together via the wireless communication network that may be common to both of said units, following an instruction given by the control unit of the trigger device.

The communication units can communicate via two types of radio networks: short-range, of the order of a few dozen meters for machine shutdowns, and long-range, of the order of a kilometer for relaying distress alerts.

The safety device can be adapted to a wide variety of electromechanical equipment items, that is to say machines and vehicles.

The safety device can allow a single device to be used to cover a wide range of safety situations. The safety device can reduce the need for multiple specialized systems. The versatility of the system is enhanced by its ability to respond to two different types of event with a single device.

The fact that the safety device can remotely stop an electromechanical equipment item following the detection of an event of the first type can allow a rapid reaction in the event of danger without requiring the physical presence of an operator in the immediate vicinity of the equipment item. The safety device can also improve safety in the working environment by allowing the immediate shutdown of potentially dangerous electromechanical equipment items. The risk of accidents associated with the use of electromechanical equipment items can be reduced.

The fact that the safety device can send out a distress alert following the detection of an event of the second type can allow rapid reporting of emergency situations and thus potentially improve the response time of emergency services. In this way, the safety device can enhance the personal safety of users, particularly in isolated or hazardous working environments.

Combining the event detection module, the communication unit and the control unit in a single trigger device can reduce the processing time between event detection and system response.

The fact that the safety system can react differently depending on the type of event detected can help optimize the response according to the severity or nature of the situation. The device can also help reduce false alarms, while allowing graduated responses.

Being able to trigger two distinct types of action with a single trigger device can simplify the user interface while maintaining dual functionality. This makes the devices more compact and multifunctional. The single trigger device can make it easier to learn and use the safety device.

By virtue of the invention, the single trigger device can detect both an event of the first type and an event of the second type and trigger the associated response in a dissociated or cumulative manner. The synergy of these two functions means that the trigger device can help prevent, avoid and speed up the management of a wide variety of workplace accidents. The same trigger device can thus provide a dual function, with two distinct functions, emergency machine stoppage and distress beacon triggering, which can be triggered separately or cumulatively.

Advantageously, the trigger device includes means for attaching it to a smartphone.

The means for attaching the trigger device may include means for wired connection to a smartphone, for example of the USB-C type, for recharging and/or powering said trigger device. The attaching means are designed to be compatible with all smartphones.

The attaching means for the trigger device may include means for communication between the smartphone and said trigger device. The communication means may be via a wired connection.

The means of attaching the trigger device may include attaching means to the smartphone or smartphone shell. The attaching means can be magnetic, adhesive or hook-and-loop, or they can form a dedicated shell for the smartphone incorporating the trigger device.

The trigger device can include a secondary charging port that can allow the smartphone to be charged without disconnecting said trigger device. This feature can make it easier to use, and increases the likelihood of use, since once the detection device is plugged in, it remains in place and the user no longer has to worry about plugging it in or unplugging it to charge the smartphone.

Being able to attach the trigger device directly to the smartphone can make it possible to use certain smartphone resources, such as its battery, satellite positioning system or communication networks. In fact, using the smartphone's GPS location can help to pinpoint the user's precise location in the event of an emergency.

Using smartphones can allow creation of detailed user profiles tailored to the specific needs of each user.

Advantageously, the trigger device includes wireless coupling means.

The use of wireless coupling means can allow the trigger device to connect to at least one receiver device without requiring a physical connection.

The wireless coupling means of the trigger device can use three types of wireless communication networks: a short-range network suitable for machine shutdown, a long-range network suitable for distress calls in dead zones, and a Bluetooth® communication protocol suitable for communication between the trigger device and the smartphone. Using different types of communication network can increase the overall reliability of the safety system.

Advantageously, the event detection module includes a button including detection means configured to detect a press on said button, a computing unit configured to interpret the event of the first type in response to a brief press on said button, said detection of the brief press is adapted to trigger a first action associated with said event of the first type.

A brief press on the button can be detected by the detection means, allowing the computing unit to interpret an event of the first type. The brief press can be defined as the act of pressing the button, regardless of how long the button is held down after the press.

The first type of event may be detected in response to a manual action by the user by a brief press on the detection means.

In one embodiment, the first action of the first type can trigger an emergency stop of the electromechanical apparatus on which the receiver device is mounted. In another embodiment, the first action of the first type can trigger an emergency stop of all electromechanical apparatuses on which a receiver device is within signal range. The first action may be a risk prevention action, to prevent a risky situation from worsening or occurring in the first place.

Advantageously, the computing unit is configured to interpret the event of the second type in response to a prolonged press on the button, said detection of the prolonged press being adapted to trigger a second action associated with said event of the second type.

A prolonged press on the detection means can allow the computing unit to interpret an event of the second type. The prolonged press can be defined by a press duration greater than a predetermined threshold duration. Any prolonged press automatically triggers a short press and the interpretation of an event of the first type, and this press is transformed into a prolonged press detected as an event of the second type on the sole condition that the duration of the press exceeds a threshold value.

The second type of event may be detected in response to a manual action by the user by a prolonged press on the button.

The second action, corresponding to the second type of event, can trigger a distress call which may automatically involve an emergency stop of the electromechanical apparatus on which the receiver device is mounted. The second action could be to speed up the handling of an accident.

When an event of the second type is detected by the button on the event detection module, the event of the first type has necessarily been detected upstream and the second action is triggered after the first action. The trigger device can thus introduce a notion of event hierarchy and a gradation in the system's response based on the seriousness of the situation.

The detection of a prolonged press on the button to trigger a second action corresponding to an event of the second type can reduce the risk of accidental triggering of the distress call function, reducing nuisance calls to emergency services or the launch of an involuntary alert. In this way, the prolonged press can trigger two distinct actions in succession, reducing the complexity of using the device, particularly in emergency situations.

Advantageously, the event detection module includes a motion sensor.

The motion sensor may be an inertial measurement system. The motion sensor can capture data that can be interpreted by the appropriate computing unit to identify unusual movements such as falls and/or impacts and/or sudden movements and/or prolonged inactivity. When the computing unit interprets one of these unusual movements from the data measured by the motion sensor, the control unit can automatically trigger a first or second action associated with the first or second type of event by the event detection module. This automatic response can avoid or anticipate manual intervention by the user, particularly if the user is unable to trigger the detection module manually.

Interpretation of the motion sensor data by the computing unit can allow detection of an event of the first type and an event of the second type depending on the user's movements, such as falls, impacts or periods of immobility exceeding one or more predetermined thresholds. The trigger conditions can be interpreted by suitable algorithms to study the user's movements. The algorithms can interpret the linear and angular accelerations detected by the inertial unit of the motion sensor. In another embodiment, the detection of the first type of event may be in response to an automatic detection done by algorithms that may be contained in the computing unit. In another embodiment, the detection of the second type of event may be in response to an automatic detection done by algorithms that may be contained in the computing unit.

The distress call can be triggered by pressing and holding the button, or by detecting a critical situation.

Machine stoppage can be triggered by a brief press on the button, or when a critical situation is detected.

Advantageously, the receiver device is configured to cooperate directly with the electromechanical equipment item.

A physical, mechanical and/or electronic functional link may exist between the receiver device and the electromechanical equipment item. The receiver device can be connected to the electromechanical equipment item.

The second communication unit can receive the data sent by the first communication unit and then a second control unit can interpret this data so that the action unit generates a response corresponding to the event detected by the event detection module of the single trigger device, that is to say it can either cause the power supply to the electromechanical equipment item to be cut off or give a machine stoppage command to the system of said electromechanical equipment item.

Installing a wireless shutdown system for the electromechanical equipment item, and transferring the shutdown trigger device to the user, can reduce the time taken to activate the shutdown trigger device, and as a result the time between identifying an incident and shutting down the machines. This system can also be used in situations where the worker does not have direct access to a wired shutdown system, or where the electromechanical equipment item is not equipped with a wired shutdown system.

Advantageously, the action unit of the receiver device is configured to cause a shutdown of the electromagnetic equipment item.

The action unit can be used as an emergency shutdown system. The emergency shutdown system of the electromechanical device can correspond to the button of the single trigger device, and can thus be offloaded directly to the user.

In one embodiment, the action unit of a receiver device can, for example, perform the first action, that is to say switching off the electromechanical device equipped with a receiver device if this is closest to the individual carrying the single trigger device having detected a first or second type of event.

In another embodiment, each action unit of each receiver device can, for example, perform the first action, that is to say switching off the electromechanical device equipped with a receiver device if the latter is present within a limited perimeter around the individual carrying the single trigger device having detected a first or second type of event.

Performing an action of the first type can allow rapid shutdown of the electromechanical device and can prevent or limit potential property damage and injury. A rapid shutdown can be achieved by reducing the time required to activate the electromechanical equipment shutdown, by virtue of the presence of the button of the single trigger device positioned as close as possible to the user.

Generally speaking, when an electrical power cut occurs on an electrical machine, it is not always made safe, since kinetic energy can be stored in the moving parts of said machine. On this type of machine present a kinetic hazard, it is therefore necessary to use a specific receiver adapted to communicate with the safety systems of the machine to stop it effectively.

Advantageously, the stop instruction is associated with any type of electromechanical equipment item.

The coding of the action unit can include a unique code adapted to communicate with any type of electromechanical equipment item.

Advantageously, the stop instruction is associated with a type of electromechanical equipment item.

The stop instruction, that is to say the information transmitted by the single trigger device to the receiver device, can be associated with one or more types of receiver device. There may be several types of stop command, each associated with one or more types of receiver, depending on how it has been programmed to work with the electromechanical equipment item on which it is mounted.

In the event of an emergency stop, the single trigger device instructs the machine-mounted receiver devices to stop the machines.

Advantageously, the control unit is adapted to transmit a status confirmation request from a user and, in the absence of a response, to transmit the distress alert.

When an event of the second type is detected after a prolonged press on the button, the control unit is adapted to transmit a notification to its user, for example via a dedicated mobile application. The notification sent to the user can be in the form of a query about the user's state of health. If there is no response from the user for longer than a predetermined time, the control unit can be adapted to transmit a distress call. In the event of a distress call, the control unit instructs the mobile application to call the emergency numbers. The application launches a call loop on a base of preregistered numbers until a response is received.

The control unit can therefore operate using a two-stage verification system, that is to say sending a status confirmation request and responding or not responding to said request, before sending a distress alert, which can limit the number of false alerts while ensuring that help is sent when it is actually needed.

This confirmation request can be used to check whether the user actually needs help.

Advantageously, the control unit is adapted to transmit a user status confirmation request and, or in the event of confirmation of a distress condition, to transmit the distress alert.

When an event of the second type is detected after a prolonged press on the button, the control unit is adapted to transmit a notification to the user, for example via a dedicated mobile application. The notification sent to the user can be in the form of a query about the user's state of health. In the event or in case of confirmation of a distress condition, e.g. “I'm not well” or “I need help” from the user, the control unit can then be adapted to transmit a distress call. In the event of a distress call, the control unit instructs the mobile application to call the emergency numbers. The application launches a call loop on a base of preregistered numbers until a response is received.

The control unit can therefore operate using a two-stage verification system, that is to say sending a status confirmation request and responding or not responding to said request, before sending a distress alert, which can limit the number of false alerts while ensuring that help is sent when it is actually needed.

This confirmation request can be used to check whether the user actually needs help.

Advantageously, the first communication unit is adapted to cooperate with a wireless communication network and, in the absence of communication with said wireless communication network, to cooperate with a dedicated radio network.

The first communication unit can include three communication modules, such as Bluetooth®, a short-range module and a long-range module. In the event the smartphone is unable to communicate via its own usual communication networks to send a distress alert, the device is adapted to switch to another wireless communication mode. The wireless communication network can pass through an intermediary, such as a public long-range wireless communication network. This network can be used for long-range communication. When the smartphone is unable to communicate via its own networks and the device cannot connect to the public long-range network, the device can be adapted to perform direct communication via a private long-range radio network. The fact that the first communication unit can take over the smartphone's communication networks with long-range radio networks can provide redundancy in sending alerts and information even if the smartphone's standard communication networks are unavailable or overloaded.

This dual coverage system means that the device can be rapidly deployed in new environments without relying on the existing network infrastructure.

Advantageously, the smartphone is adapted to trigger a predetermined call sequence following an instruction from the single trigger device via the first communication unit.

If the communication networks of the smartphone are available, the smartphone can launch the call loop. The content of the call may indicate the identity of the individual, his location, the type and conditions of the accident that have been detected, and the presence or absence of proximate electromechanical devices in the vicinity.

Another aspect of the invention relates to the ability of a single safety device to operate a plurality of single trigger devices together.

Using a plurality of single trigger devices can allow team operation, that is to say if an accident occurs or a first type of event is detected on one of the single trigger devices, then a first action can be triggered for the user wearing the first single trigger device, but also for a second user wearing a second single trigger device.

Using a plurality of single trigger devices can make it possible to cover larger geographical areas than with just one single trigger device. Single trigger devices can be added to receiver devices to relay alerts and information.

### BRIEF DESCRIPTION OF THE FIGURES

Further advantages and features of the present invention are now described with the aid of examples which are illustrative only and by no means limit the scope of the invention, and from the appended drawings, in which the various figures represent:

FIG. 1 schematically shows a front view of a trigger device mounted on a rear panel of a smartphone according to one embodiment of the invention.

FIG. 2 schematically shows a perspective view of a first type of receiver device according to one embodiment of the invention.

FIG. 3 schematically shows a perspective view of a second type of receiver device according to one embodiment of the invention.

In the following description, identical elements, by structure or function, appearing on different figures retain the same references, unless otherwise specified.

### DESCRIPTION OF AN EMBODIMENT

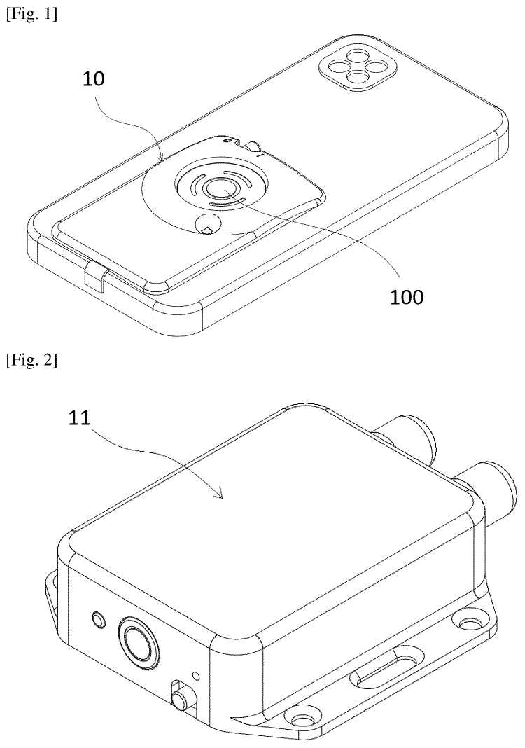

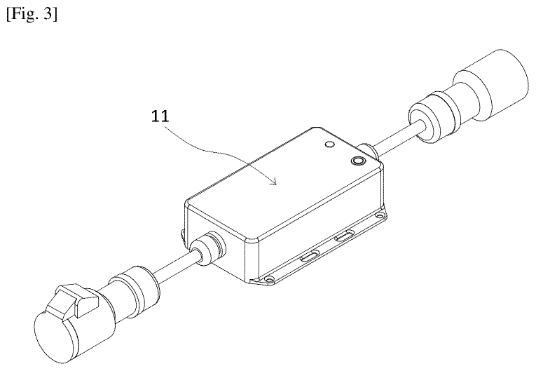

A schematic view of a safety device according to one embodiment is shown in FIG. 1. The safety device is also described in connection with FIG. 2 and FIG. 3 showing a schematic view of a trigger device 10 of the safety device and FIG. 3 showing a schematic view of a receiver device 11 of said safety device.

The safety device includes a trigger device 10 and a receiver device 11 adapted to cooperate with one another.

The safety device includes a housing on which an event detection module is mounted. The single trigger device 10 includes the event detection module. The single trigger device 10 includes a button 100.

The trigger device 10 includes a first communication unit capable of exchanging data using a communication network, which may be wireless. The trigger device 10 includes a control unit.

The trigger device 10 includes means for attaching it to a smartphone. The trigger device attaching means include wired connection means for recharging said trigger device 10. The attaching means for the trigger device 10 include attaching means to the smartphone or smartphone shell. The attaching means include a magnetic or adhesive fastener. The trigger device 10 includes a secondary charging port that allows the smartphone to be charged without disconnecting said trigger device 10.

The event detection module includes a motion sensor. The motion sensor includes an inertial measurement unit to detect falls and/or sudden movements and/or prolonged inactivity.

The safety device includes a receiver device 11. The receiver device is suitable for mounting on an electromechanical equipment item such as agricultural or industrial machinery. The receiver device 11 is configured to cooperate directly with the electromechanical equipment item. The receiver device 11 is adapted to be connected to the electromechanical equipment item.

The receiver device 11 includes an action unit and is adapted to be mounted so as to be directly connected to the power supply of the electromechanical device for its own power supply, but also so that said action unit can interrupt the operation of said electromechanical equipment item. The action unit allows use as an emergency stop system. The emergency stop button of the electromechanical device is thus directly offloaded to the user.

The receiver device 11 is suitable for mounting on any existing electromechanical equipment item. The action unit is adapted to interrupt operation of the electromechanical equipment item either directly or indirectly.

The receiver device 11 includes a second communication unit capable of exchanging data using a wireless communication network.

The first communication unit of the trigger device 10 and the second communication unit of the receiver device 11 are adapted to communicate together via the wireless communication network that is common to both of said units, following an instruction given by the control unit of the trigger device 10. The second communication unit receives the data sent by the first communication unit, then interprets this data so that the action unit generates a response corresponding to the event detected by the detection module, namely that it stops the power supply to said electromechanical equipment item.

The trigger device 10 includes wireless coupling means that allow the trigger device 10 to connect to at least one receiver device 11 without requiring a physical connection.

The button 100 includes detection means configured to detect a press on said button, a computing unit configured to interpret the event of the first type in response to a brief press on said button, said detection of the brief press is adapted to trigger a first action associated with said event of the first type. Thus, following detection of an event of a first type by the button 100, the control unit is arranged to transmit an instruction to stop the equipment item to the receiver device 11, via the first and second wireless communication units. The action unit of the receiver device 11 is arranged to interrupt operation of the electromechanical equipment item on receipt of the stop instruction.

The first type of event is detected in response to a manual action by the user by a brief press on the detection means.

The computing unit of the button 100 is configured to interpret the event of the second type in response to a prolonged press on the button, said detection of the prolonged press being adapted to trigger a second action associated with said event of the second type. The second action of the second type triggers an emergency stop of the electromechanical apparatus on which the receiver device 11 is mounted, as well as a distress call. Following detection of an event of a second type by said detection module, the control unit is adapted to transmit the distress alert via the first communication unit.

A prolonged press on the button 100 allows the computing unit to interpret an event of the second type. The prolonged press is defined by a duration greater than a predetermined threshold duration.

The distress call can be triggered after a prolonged press of the button 100, or if a critical situation is detected, such as a violent fall by the user, an impact, prolonged immobilization of the user, an emergency stop of the machines or a tilting of the electromechanical equipment item.

The second type of event is detected in response to a manual action by the user by a prolonged press on the detection means.

When an event of the second type is detected, the event of the first type has necessarily been detected upstream and the second action is triggered after the first action.

In this way, the button 100 is used to detect an event of the first type and an event of the second type, although the two types of event are distinct. Based on the interaction between the user and the button 100 or on the data captured by the motion sensor, the event detection module therefore detects whether the user is facing an event of the first type or an event of the second type.

When the computing unit interprets an unusual movement from the data measured by the motion sensor, the control unit automatically triggers a first or second action associated with the first or second type of event, based on the measured data.

To avoid false alarms, the control unit is adapted to transmit a status confirmation request to the user and, in the absence of a response, to transmit the distress alert. The control unit is also adapted to transmit a user status confirmation request and, or in the event of confirmation of a distress condition, to transmit the distress alert.

When an event of the second type is detected, the control unit transmits a request to the user to confirm his status before transmitting the distress call. The status confirmation alert is sent to the user's smartphone. The distress call is then transmitted if a distress condition is confirmed or if the user fails to respond to the status confirmation request. The application then launches a call loop on a base of preregistered numbers until a response is received. When the list of preregistered numbers is exhausted, the system will restart calls from the first number on the list until an answer is received. The control unit operates using a two-stage verification system before sending a distress alert, which can limit the number of false alerts while ensuring that help is sent when it is actually needed.

The foregoing description clearly explains how the invention achieves its stated objectives, namely to provide a device for preventing and averting accidents and, in the event of an accident, mitigating the consequences and speeding up their handling, by providing a safety device including a trigger device and a receiver device which are capable of communicating with one another. The trigger device includes a single button adapted to recognize both an event of a first type and an event of a second type, these two events being quite distinct from one another.

This objective is achieved by being able to trigger two distinct types of action with a single button, thus optimizing the response according to the severity or nature of the situation, and providing rapid emergency notification capability.

In any event, the invention is not limited to the embodiments specifically described in this document, and extends in particular to any equivalent means and to any technically operative combination of such means.

1. An alert and safety device for an electromechanical equipment item including:
A single trigger device (10) comprising an event detection module, a first communication unit able to exchange data and a control unit;
At least one receiver device (11) including a second communication unit able to exchange data with said first communication unit and an action unit able to interrupt the operation of an electromechanical equipment item with which it is associated;
Characterized in that:
Following detection of an event of a first type by said detection module,
the control unit is arranged to transmit to the receiver device (11), via the first and second wireless communication units, an instruction to stop the equipment item, and
the action unit of said receiver device (11) is arranged to, upon receipt of said stop instruction, interrupt operation of said electromechanical equipment item,
Following detection of an event of a second type by said detection module, the control unit is adapted to transmit, via the first communication unit, a distress alert.

2. The safety device according to claim 1, characterized in that the trigger device (10) includes means for attaching it to a smartphone.

3. The safety device according to claim 1, characterized in that the trigger device (10) includes wireless coupling means.

4. The safety device according to claim 1, characterized in that the event detection module includes a button (100) including:
detection means configured to detect a press on said button (100),
a computing unit configured to interpret the event of the first type in response to a brief press on said button (100),
said detection of the brief press is adapted to trigger a first action associated with said event of the first type.

5. The safety device according to claim 4, characterized in that the computing unit is configured to interpret the event of the second type in response to a prolonged press on the button (100), said detection of the prolonged press being adapted to trigger a second action associated with said event of the second type.

6. The safety device according to claim 1, characterized in that the receiver device (11) is configured to cooperate directly with the electromechanical equipment item.

7. The safety device according to claim 1, characterized in that the control unit is adapted to transmit a status confirmation request from a user and, in the absence of a response, to transmit the distress alert.

8. The safety device according to claim 1, characterized in that the control unit is adapted to transmit a user status confirmation request and, or in the event of confirmation of a distress condition, to transmit the distress alert.

9. The safety device according to claim 1, characterized in that the first communication unit is adapted to cooperate with a wireless communication network and, in the absence of communication with said wireless communication network, to cooperate with a dedicated radio network.

10. The safety device according to claim 1, characterized in that the smartphone is adapted to trigger a predetermined call sequence following an instruction from the single trigger device (10) via the first communication unit.

11. A safety system including a safety device according to claim 1, referred to as a first safety device, and a second, substantially identical safety device.
